(19) United States
(12) Patent Application Publication
(10) Pub. No.: US 2026/0266973 A1
(43) Pub. Date: Sep. 10, 2026

(54) LIDAR AND DIRT DETECTION DEVICE FOR WINDOW AND LENS OF LIDAR

(71) Applicant: AUTOX TECH PTE. LTD., SINGAPORE (SG)

(72) Inventors: Zhuo Li, Shenzhen (CN); Yizhou Shan, Shenzhen (CN); Menglei Ji, Shenzhen (CN); Gaowen Deng, Shenzhen (CN); Tuo Cai, Shenzhen (CN); Guiqin Liang, Shenzhen (CN); Weibiao Wu, Shenzhen (CN)

(73) Assignee: AUTOX TECH PTE. LTD., SINGAPORE (SG)

(21) Appl. No.: 19/191,114

(22) Filed: Apr. 28, 2025

(30) Foreign Application Priority Data
Mar. 7, 2025 (CN) 2025102761043

(51) Int. Cl. G01S 7/497; G01J 5/00; G01J 5/08; G01S 7/481; G06T 7/00; H04N 23/20; H04N 23/72; H04N 23/73; H04N 23/74

(52) U.S. Cl. CPC G01S 7/497; G01J 5/0859; G01S 7/4813; G06T 7/0002; H04N 23/20; H04N 23/72; H04N 23/73; H04N 23/74; G01J 2005/0077; G01S 2007/4975; G06T 2207/10048

(57) ABSTRACT

The disclosure provides a dirty detection device for a LiDAR, the LiDAR includes a window and an optical lens facing the window. The dirty detection device for the LiDAR is configured to detect whether the optical lens or the window is dirty. The dirty detection device includes a camera for capturing images of the optical lens and the window, the images being analyzed to determine whether the optical lens and the window are dirty; and an illumination component disposed inside the LiDAR, the illumination component being used for illumination, and the illumination range covering the window and the optical lens. Furthermore, the disclosure also provides a LiDAR.

### CROSS REFERENCE TO RELATED APPLICATION

This non-provisional patent application claims priority under 35 U.S.C. § 119 from Chinese Patent Application No. 202510276104.3 filed on Mar. 7, 2025, the entire content of which is incorporated herein by reference.

### TECHNICAL FIELD

The disclosure relates to the field of LiDAR, and in particular to a LiDAR, and a dirt detection device for a window and a lens of the LiDAR.

### BACKGROUND

At present, detection of a LiDAR window and a lens module cannot be performed in real time during the working state of the LiDAR. Detection during the working state has signal interference, which affects the quality of signals received by the LiDAR, and it is difficult to detect abnormal working states of the window and the lens module.

Image acquisition data of a LiDAR camera depends on a certain light intensity. However, in the case of insufficient ambient light outdoors at night, the camera cannot normally capture images with sufficient brightness. Moreover, during the rotation of the LiDAR, the rotation of the rotating part itself will cause motion blur in the camera, resulting in unclear images captured by the camera, and it is difficult to complete image detection to meet the requirement of detecting the LiDAR window and lens.

### SUMMARY

The disclosure provides a dirty detection device and a LiDAR for a LiDAR, to detect whether the optical lens and the window are dirty or damaged.

In a first aspect, the disclosure provides a dirty detection device for a LiDAR. The LiDAR includes a window and an optical lens facing the window. The dirty detection device is configured to detect whether the optical lens or the window is dirty. The dirty detection device includes a camera and an illumination component. The camera is configured to capture images of the optical lens and the window, and the images are analyzed to determine whether the optical lens and the window are dirty. The illumination component is disposed inside the LiDAR, and the illumination component is configured to illuminate, and illumination range covers the window and the optical lens.

In a second aspect, the disclosure provides a LiDAR, and the LiDAR include a window, a optical lens facing the window, and the dirty detection device for a LiDAR.

The above dirty detection device for a LiDAR and the LiDAR detect the optical lens and the window through the camera and the illumination component to confirm any abnormal working states of the window and the lens module, such as contamination, cracking, damage, displacement, etc. The dirty detection device for a LiDAR provided by the disclosure can realize detection of the optical lens and the window when the LiDAR is in an operating state and a non-operating state, effectively improving the working efficiency of the LiDAR, timely detecting its working state and processing the LiDAR, effectively avoiding interference with the detection action of the LiDAR, providing a basis for cleaning of the LiDAR and driving dynamics of a vehicle, better detecting surrounding environments, and assisting driving safety.

### BRIEF DESCRIPTION OF THE DRAWINGS

To more clearly illustrate the technical solutions in the embodiments of the disclosure or in the prior art, the drawings to be used in the description of the embodiments or the prior art will be briefly introduced below. It is apparent that the drawings described below are merely some embodiments of the disclosure, and for those of ordinary skill in the art, other drawings can be obtained based on the structures shown in these drawings without creative efforts.

FIG. 1 is a schematic structural diagram of a dirty detection device for a LiDAR at a first angle in accordance with an embodiment.

FIG. 2 is a schematic structural diagram of a dirty detection device for a LiDAR at a second angle in accordance with an embodiment.

FIG. 3 is a simplified schematic structural diagram of a dirty detection device for a LiDAR in accordance with an embodiment.

FIG. 4 is another simplified schematic structural diagram of a dirty detection device for a LiDAR in accordance with an embodiment.

FIG. 5 is a schematic diagram of a detection method of a dirty detection device for a LiDAR in accordance with an embodiment.

FIG. 6 is a schematic diagram of an overall structure of a LiDAR in accordance with an embodiment.

The realization of the objectives, functional features, and advantages of the disclosure will be further described below in conjunction with the embodiments with reference to the drawings.

### DETAILED DESCRIPTION OF THE EMBODIMENTS

To make the objectives, technical solutions, and advantages of the disclosure clearer, the disclosure will be further described in detail below in conjunction with the drawings and embodiments. It should be understood that the specific embodiments described herein are merely used to explain the disclosure, and are not used to limit the disclosure. All other embodiments obtained by those of ordinary skill in the art based on the embodiments of the disclosure without creative efforts fall within the protection scope of the disclosure.

The terms “first,” “second,” “third,” “fourth,” and the like (if present) in the specification, claims, and the above drawings of the disclosure are used to distinguish similar objects, and are not necessarily used to describe a specific order or sequence. It should be understood that such used data may be interchangeable under appropriate circumstances. In other words, the described embodiments may be implemented in sequences other than those illustrated or described herein. In addition, the terms “comprising” and “having,” as well as any variations thereof, are intended to cover non-exclusive inclusions. For example, a process, method, system, product, or device that includes a series of steps or units is not necessarily limited to those steps or units that are clearly listed, but may include other steps or units that are not clearly listed or are inherent to such processes, methods, products, or devices.

It should be noted that descriptions related to “first,” “second,” etc., involved in the disclosure are merely used for description purposes, and cannot be interpreted as indicating or implying relative importance or implicitly specifying the number of technical features indicated. Therefore, features defined with “first” and “second” may explicitly or implicitly include one or more of the features. In addition, technical solutions among various embodiments may be combined with each other, but must be based on the premise that they can be realized by those of ordinary skill in the art. When the combination of technical solutions contradicts each other or cannot be realized, it should be considered that the combination of such technical solutions does not exist and is not within the protection scope claimed in the disclosure.

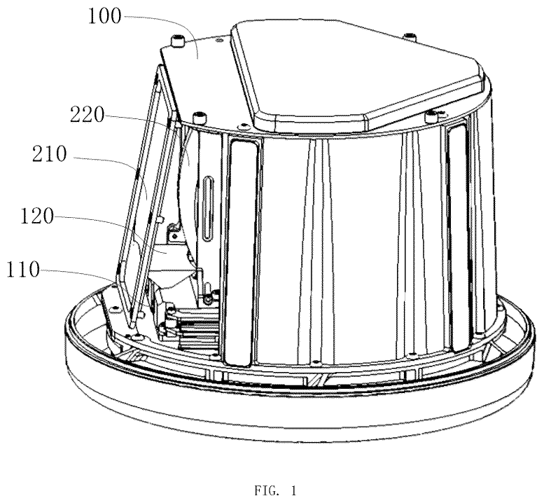

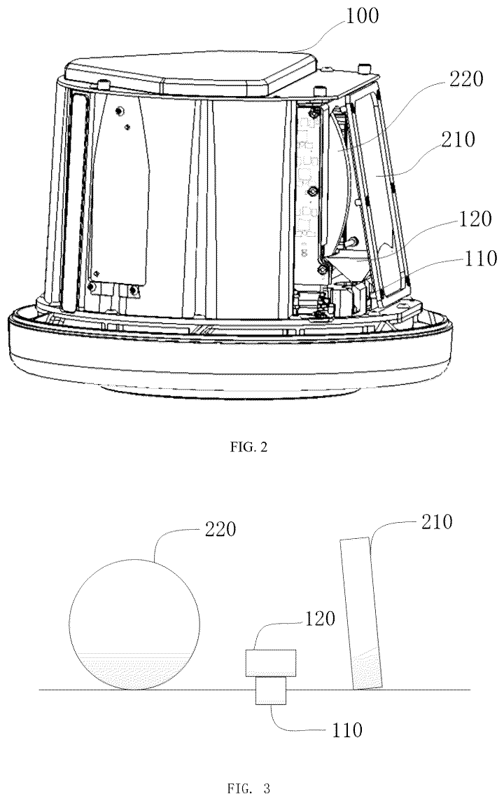

Referring to FIGS. 1 to 2, FIG. 1 is a schematic structural diagram of a dirty detection device 100 for a LiDAR at a first angle in accordance with an embodiment. FIG. 2 is a schematic structural diagram of the dirty detection device 100 at a second angle in accordance with an embodiment. The dirty detection device 100 provided by the embodiment of the disclosure is applied to the LiDAR 200. The LiDAR 200 comprises a window 210 and an optical lens 220 facing the window. The dirty detection device 100 is configured to detect whether the window 11 or the optical lens 12 is dirty, cracked, damaged, displaced, etc. The dirty detection device 100 comprises a camera 110 and an illumination component 120.

The camera 110 is configured to capture images of the window 210 and the optical lens 220. The images are analyzed to determine whether the window 210 and the optical lens 220 are dirty. The camera 110 is an infrared camera, and the infrared light waveband of the infrared camera matches the operating light waveband of the LiDAR 200. The camera 110 is further provided with a camera lens, preferably a camera lens with a short pixel exposure time, to avoid motion blur in the camera due to rotation of the LiDAR 200 during normal operation, resulting in unclear captured images and affecting image recognition. A camera lens with a short exposure time can complete scanning actions in a short time. The camera 110 matches the light transmission light waveband of the optical lens 220, including camera products of 905 nm, 940 nm, 1550 nm, and other light wavebands.

The illumination component 120 is disposed inside the LiDAR 200 together with the camera 110. The illumination component 120 is configured to illuminate, and the illumination range covers the window 210 and the optical lens 220. The illumination component 120 is preferably an LED infrared fill light, which can improve image brightness and compensate for insufficient ambient light, avoiding insufficient image brightness and unclear images captured by the camera 110 under poor lighting conditions. The illumination component 120 emits infrared light, and the light waveband of the infrared light matches the operating light waveband of the LiDAR 200. In this embodiment, the illumination component 120 emits infrared light of light wavebands corresponding to the light transmission light wavebands of the camera 110, including 905 nm, 940 nm, 1550 nm, and other light wavebands.

The above dirty detection device for a LiDAR 100 detects the window 210 and the optical lens 220 through the camera 110 and the illumination component 120 to confirm contamination, cracking, damage, displacement, etc., of the window 210 and the optical lens 220. The dirty detection device 100 effectively improves the working efficiency of the LiDAR 200 and can timely detect the working states of the window 210 and the optical lens 220 and process the LiDAR 200.

Referring to FIG. 3, FIG. 3 is a simplified schematic structural diagram of a dirty detection device for a LiDAR in accordance with an embodiment. In this embodiment, the camera 110 and the illumination component 120 may be disposed inside the LiDAR 200 and located between the window 210 and the optical lens 220 to ensure that the camera lens of the camera 110 can be aligned with the optical lens 220 and the window 210 at the same time. The illumination component 120 is installed on the camera 110 to provide illumination for the camera 110, so as to ensure sufficient brightness is maintained even in a dim environment. Moreover, the optical lens 220, the camera 110, and the illumination component 120 use light beams of the same light waveband, and the window 210 can transmit light beams of this light waveband.

In this embodiment, the camera 110 captures images during non-detection time of the LiDAR 200. The non-detection time is the time when the LiDAR 200 stops working or the interval between two measurement cycles of the LiDAR 200.

When the LiDAR 200 is in a stopped state, the window 210, the optical lens 220, the camera 110, and the illumination component 120 are all in a stationary state. At this time, the camera 110 is located inside the LiDAR 200, and the camera lens of the camera 110 faces the window 210 and the optical lens 220. Images containing both the window 210 and the optical lens 220 are captured. The illumination component 120 provides illumination for the camera 110 under insufficient ambient light conditions. In detail, the illumination component 120 adopts a continuous lighting mode. In this continuous lighting mode, the illumination component 120 continuously illuminates the inside of the LiDAR 200. At this time, the camera 110 can capture images inside the LiDAR 200 at any time and any frequency. It may cause interference during the operation of the LiDAR 200, so relevant measures need to be taken to remove the interference to the LiDAR 200. First, the optical path of the illumination component 120 can be taken into account during the design process to ensure that it has as little impact as possible on the signal quality received by the LiDAR 200. Additionally, software and algorithms can be employed to remove the noise generated by the illumination component 120. Alternatively, by restricting the usage scenarios, the illumination and images-capturing can be carried out during the time when the LiDAR 200 stops operating.

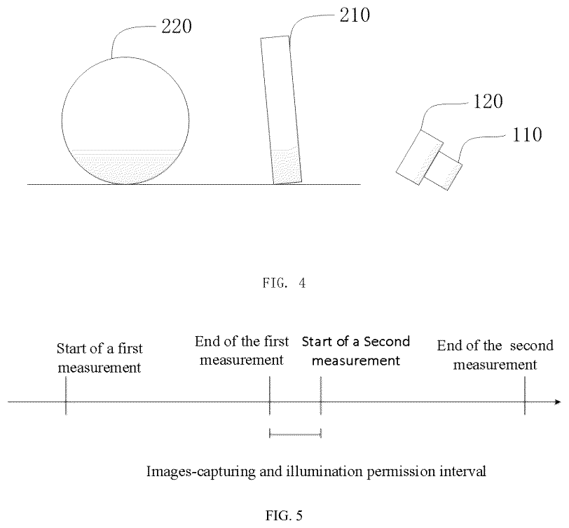

Referring to FIG. 5, FIG. 5 is a schematic diagram of a detection method of a dirty detection device for a LiDAR in accordance with an embodiment.

When the LiDAR 200 is in an operating state, the camera 110 and the illumination component 120 are relatively stationary with the window 210. That is, when the LiDAR 200 is in an operating state, the camera 110 and the illumination component 120 rotate with the window 210. There is a first time interval from the start of a first measurement to the end of the first measurement during the operation of the LiDAR 200, and the first time interval is the permitted interval for the camera 110 and the illumination component 120 to capture images and illuminate. During the first time interval, the camera 110 can complete images-capturing actions without causing interference to the detection of the LiDAR 200. Then, there is a second time interval from the start of a second measurement to the end of the second measurement. The camera 110 captures pictures of the window 210 and the optical lens 220 during the second time interval, and the captures images containing both the optical lens 220 and the window 210, and this process then repeats cyclically. The illumination component 120 provides illumination for the camera 110 under insufficient ambient light conditions. In this state, the illumination component 120 adopts an indirect lighting method. In this indirect lighting method, the illumination component 120 illuminates the inside of the LiDAR 200 during the permitted illumination interval. The camera 110 and the illumination component 120 complete illumination and images-capturing actions during intervals between any two measurement cycles. The interval time between the start and end of measurement can be adjusted according to the system state, so the images-capturing and illumination permission interval also needs to be adjusted according to the system state to meet the purpose of non-interference between measurement and illumination. Under the indirect illumination method, the camera 110 can be exposed for a long time to accumulate sufficient image brightness. The exposure time must include at least one illumination time here to ensure that illuminated photons enter the camera 110. After the camera 110 captures images containing both the window 210 and the optical lens 220, whether the optical lens 220 and the window 210 are in abnormal states is determined through image recognition. Image detection methods include manual algorithm detection, machine learning detection, or other image detection methods.

Referring to FIG. 4, FIG. 4 is another simplified schematic structural diagram of a dirty detection device for a LiDAR in accordance with an embodiment. The camera 110 and the illumination component 120 may be disposed outside the LiDAR 200 to observe the optical lens 220 and the window 210 from the outside. When detecting whether the optical lens 220 and the window 210 are dirty, the window 210 is controlled to align with the camera 110, so that the camera 110 can shoot the optical lens 220 and the window 210 when the LiDAR rotates to a certain angle. The illumination component 120 provides illumination for the camera 110 under poor lighting conditions, so that the camera 110 can capture images meeting brightness requirements. Moreover, the camera 110, the illumination component 120, and the optical lens 220 use light beams of the same light waveband, and the window 210 can transmit light beams of this light waveband. External detection is divided into two different detection methods: stationary state detection and motion state detection based on the working state of the LiDAR 200.

When the LiDAR 200 is in an operating state, the window 210 rotates with the rotating part of the LiDAR 200. At this time, there is relative motion between the camera 110 and the illumination component 120 and the window 210. The camera 110 and the illumination component 120 are controlled to detect within an angle range where the window 210 faces the camera 110. This detection method will cause motion blur, so the exposure time of the camera 110 needs to be controlled as short as possible. The exposure time of the camera 110 is set according to the rotation speed of the LiDAR 200. At this time, stronger external brightness is required to compensate for the problem of different image brightness, so the illumination component 120 is required to provide illumination.

When the LiDAR 200 is in a stopped state, the window 210, the optical lens 220, the camera 110, and the illumination component 120 are all in a stationary state. The LiDAR 200 is controlled to rotate so that the camera lens of the camera 110 is opposite to the window 210, that is, the window 210 is rotated to the direction of aligning with the camera 110 and the illumination component 120, and the camera 110 is configured to capture image of the optical lens 220 and the window 210 by fixing the angle of the LiDAR 200. The illumination component 120 provides illumination for the camera 110 under insufficient ambient light conditions. The illumination method is consistent with the above illumination scheme and will not be repeated here. After the camera 110 captures images containing both the window 210 and the optical lens 220, it is determined whether the optical lens 220 and the window 210 are in abnormal states through image recognition methods. Image recognition methods include manual algorithm detection, machine learning detection, or other image detection methods.

In this embodiment, the camera 110 can capture images containing both the optical lens 220 and the window 210 under the illumination of the illumination component 120, by controlling the positional relationship between the camera 110, the illumination component 120, and the window 210. After the camera 110 completes the images-capturing action, abnormal working states of the optical lens 220 and the window 210 are detected through the image recognition methods.

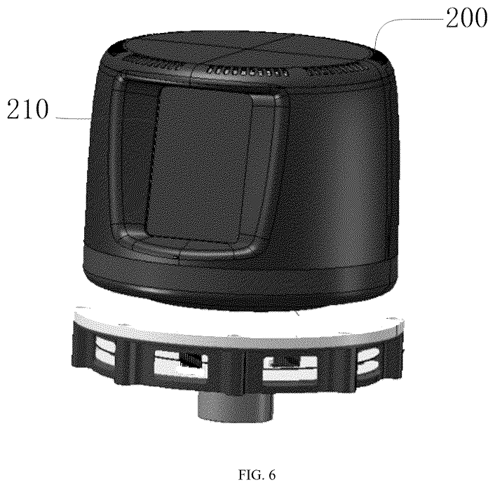

Referring to FIG. 6, FIG. 6 is a schematic diagram of an overall structure of a LiDAR in accordance with an embodiment. The disclosure further provides a LiDAR 200, applied to device, such as vehicles, ships, aircraft, robots, etc. The LiDAR 200 is a mechanically rotating LiDAR. The LiDAR 200 can perform 360° horizontal field of view scanning on surrounding environments and can provide all-around surrounding environment information for a driverless system. The LiDAR 200 comprises a window 210, an optical lens 220 facing the window, and the above dirty detection device for a LiDAR 100. The dirty detection device 100 is applied to the LiDAR 200 to detect whether the window 210 or the optical lens 220 is in an abnormal working state, such as contamination, cracking, damage, displacement, etc. For specific structures of The dirty detection device 100, please refer to the above descriptions and they will not be repeated here.

The window 210 is disposed on the rotating part of the LiDAR 200 and rotates with the rotation of the rotating part. The window 210 is configured to ensure that laser light of a specific wavelength can smoothly penetrate and can also filter stray light, having certain active anti-interference capabilities.

The optical lens 220 is configured to emit laser beams of specific wavelengths and receive return wave beams of emitted beams. In this embodiment, the optical lens 220 can emit and receive laser beams including 905 nm, 940 nm, 1550 nm, and other light wavebands to accurately detect positions of surrounding environment targets and acquire information of the targets.

The above dirty detection device for a LiDAR and the LiDAR detect the optical lens and the window through the camera and the illumination component to confirm any abnormal working states of the window and the lens module, such as contamination, cracking, damage, displacement, etc. The dirty detection device for a LiDAR provided by the disclosure can realize detection of the optical lens and the window when the LiDAR is in an operating state and a non-operating state, effectively improving the working efficiency of the LiDAR, timely detecting its working state and processing the LiDAR, effectively avoiding interference with the detection action of the LiDAR, providing a basis for cleaning of the LiDAR and driving dynamics of a vehicle, better detecting surrounding environments, and assisting driving safety.

It is apparent to those skilled in the art that various modifications and variations can be made to the disclosure without departing from the spirit and scope thereof. Therefore, if these modifications and variations of the disclosure fall within the scope of the claims of the disclosure and their equivalent technologies, the disclosure also intends to cover these modifications and variations.

It should be understood that although the steps in the flowcharts of the drawings are displayed in order indicated by arrows, these steps are not necessarily executed in the order indicated by the arrows. Unless explicitly stated in the disclosure, there is no strict order limit for execution of these steps. These steps may be executed in other orders. At least part of the steps in the flowcharts of the drawings may comprise multiple sub-steps or multiple stages. These sub-steps or stages are not necessarily executed at the same time, but may be executed at different times. The execution order thereof is not necessarily sequential, but may be alternately executed with at least part of other steps or sub-steps or stages of other steps.

The above listed are merely preferred embodiments of the disclosure, and of course, the disclosure is not limited thereto. Therefore, equivalent changes made according to the claims of the disclosure still fall within the scope covered by the disclosure.

1. A dirty detection device for a LiDAR, the LiDAR comprising a window and an optical lens facing the window, the dirty detection device being configured to detect whether the optical lens or the window is dirty, wherein the dirty detection device for the LiDAR comprises:
a camera, configured to capture images of the optical lens and the window, the images are analyzed to determine whether the optical lens and the window are dirty; and
an illumination component, is disposed inside the LiDAR, the illumination component is configured to illuminate, and an illumination range of the illumination component covers the window and the optical lens.

2. The dirty detection device for a LiDAR according to claim 1, wherein the camera and the illumination component are disposed inside the LiDAR and located between the window and the optical lens.

3. The dirty detection device for a LiDAR according to claim 2, wherein the camera is an infrared camera, and the infrared light waveband of the infrared camera matches the operating light waveband of the LiDAR.

4. The dirty detection device for a LiDAR according to claim 2, wherein the illumination component emits infrared light, and the light waveband of the infrared light matches the operating light waveband of the LiDAR.

5. The dirty detection device for a LiDAR according to claim 1, wherein the camera captures images during non-detection time of the LiDAR.

6. The dirty detection device for a LiDAR according to claim 1, wherein the camera captures images during non-detection time of the LiDAR, and the non-detection time is the time when the LiDAR stops working or the interval between two measurement cycles of the LiDAR.

7. The dirty detection device for a LiDAR according to claim 1, wherein the camera and the illumination component are disposed outside the LiDAR, and when detecting whether the LiDAR is dirty, the window is controlled to align with the camera.

8. The dirty detection device for a LiDAR according to claim 1, wherein when the LiDAR stops working, the LiDAR is controlled to rotate to be opposite to the window; and when the LiDAR rotates, the illumination component is controlled to illuminate towards the window.

9. The dirty detection device for a LiDAR according to claim 1, wherein the exposure time of the camera is determined according to the rotation speed of the LiDAR.

10. A LiDAR, comprising:
a window;
an optical lens, facing the window; and
a dirty detection device, configured to detect whether the optical lens or the window is dirty, wherein the dirty detection device for the LiDAR comprises:
a camera, configured to capture images of the optical lens and the window, the images are analyzed to determine whether the optical lens and the window are dirty; and
an illumination component, is disposed inside the LiDAR, the illumination component is configured to illuminate, and an illumination range of the illumination component covers the window and the optical lens.

11. The LiDAR according to claim 10, wherein the camera and the illumination component are disposed inside the LiDAR and located between the window and the optical lens.

12. The LiDAR according to claim 11, wherein the camera is an infrared camera, and the infrared light waveband of the infrared camera matches the operating light waveband of the LiDAR.

13. The LiDAR according to claim 11, wherein the illumination component emits infrared light, and the light waveband of the infrared light matches the operating light waveband of the LiDAR.

14. The LiDAR according to claim 10, wherein the camera captures images during non-detection time of the LiDAR.

15. The LiDAR according to claim 10, wherein the camera captures images during non-detection time of the LiDAR, and the non-detection time is the time when the LiDAR stops working or the interval between two measurement cycles of the LiDAR.

16. The LiDAR according to claim 10, wherein the camera and the illumination component are disposed outside the LiDAR, and when detecting whether the LiDAR is dirty, the window is controlled to align with the camera.

17. The LiDAR according to claim 10, wherein when the LiDAR stops working, the LiDAR is controlled to rotate to be opposite to the window; and when the LiDAR rotates, the illumination component is controlled to illuminate towards the window.

18. The LiDAR according to claim 10, wherein the exposure time of the camera is determined according to the rotation speed of the LiDAR.
